(19) United States
(12) Patent Application Publication
(10) Pub. No.: US 2025/0234276 A1
(43) Pub. Date: Jul. 17, 2025

(54) CELL SITE SELECTION BASED ON APPROVED AND NON-APPROVED CELL SITE

(71) Applicant: T-MOBILE INNOVATIONS LLC, Overland Park, KS (US)

(72) Inventors: Thomas Michael KOCH, Overland Park, KS (US); Mark Douglas PEDEN, Paola, KS (US); Raymond Emilio REEVES, Orlando, FL (US); Simon YOUNGS, Overland Park, KS (US)

(21) Appl. No.: 18/410,325

(22) Filed: Jan. 11, 2024

(51) Int. Cl. H04W 48/16; H04W 48/20

(52) U.S. Cl. CPC H04W 48/16; H04W 48/20

(57) ABSTRACT

Systems and methods are provided for preventing user equipment from communicating with non-approved third-party sites, such as simulators or IMSI catchers. Using criteria to determine whether signals are associated with approved sources, such as a base station, or non-approved sources, such as bad actors, embodiments are able to identify bad actors and prohibit attempted connections. User equipment (UE) can use a blacklist, or graylist, of sites to avoid, which conserves time and resources. Because a UE avoids third-party sites, the UE communicates with approved network devices and is able to successfully access emergency services.

### SUMMARY

A high-level overview of various aspects of the invention are provided here, to provide an overview of the disclosure and to introduce a selection of concepts that are further described in the detailed-description section below. This summary is not intended to identify key features or essential features of the claimed subject matter, nor is it intended to be used as an aid in isolation to determine the scope of the claimed subject matter. The present disclosure is directed, in part, to systems and methods for the treatment of third-party sites, such as simulators, substantially as shown in and/or described in connection with at least one of the figures, and as set forth more completely in the claims.

In aspects set forth herein, and at a high level, the systems and methods comprise receiving signals from cell sites, determining that one cell site is an approved cell site and another cell site is not approved, and connecting to the approved cell site. In embodiments, systems detect third-party sites based on signals or messages broadcast by the sites and eliminate the non-approved sites as potential connection points. In other aspects, systems and methods prevent a mobile device from communicating with certain sites based on a “blacklist,” which facilitates the mobile device communicating with an approved base station instead of a third-party device.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, wherein:

FIG. 1 depicts an example environment for accessing communication services, in accordance with aspects herein;

FIG. 2 depicts another example environment for accessing communication services, in accordance with aspects herein;

FIG. 3 depicts another example environment for accessing communication services, in accordance with aspects herein;

FIG. 4 depicts a flow diagram of an example method for facilitating a device connecting to a network, in accordance with aspects herein;

FIG. 5 depicts a flow diagram of an example method for a network device configured to process a list of sites, in accordance with aspects herein; and

FIG. 6 depicts an exemplary computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
BSID Base Station IDentifier
CD-ROM Compact Disk Read Only Memory
CDMA Code Division Multiple Access
eNB Evolved Node B
gNB Next Generation Node B
GPRS General Packet Radio Service
GSM Global System for Mobile communications
DVD Digital Versatile Discs
ECRC Emergency Call Relay Center
EEPROM Electrically Erasable Programmable Read Only Memory
EMS Enhanced Message Service
FD-MIMO Full-Dimension Multiple-Input Multiple-Output
HPLMN Home Public Land Mobile Network
IMS IP Multimedia Subsystem
IMSI International Mobile Subscriber Identifier
IoT Internet of Things
LTE Long Term Evolution
MIMO Multiple-Input Multiple-Output
MMS Multi-media Message Service
MU-MIMO Multi-User Multiple-Input Multiple-Output
NRT Neighbor Relation Table
PC Personal Computer
PDA Personal Digital Assistant
PLMN Public Land Mobile Network
PSAP Public Safety Answering Point
PEI Permanent Equipment Identifier
RAM Random Access Memory
RF Radio-Frequency
ROM Read Only Memory
RRU Remote Radio Unit
TDMA Time Division Multiple Access
VPLMN Visitor Public Land Mobile Network

In addition, words such as “a” and “an,” unless otherwise indicated to the contrary, may also include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

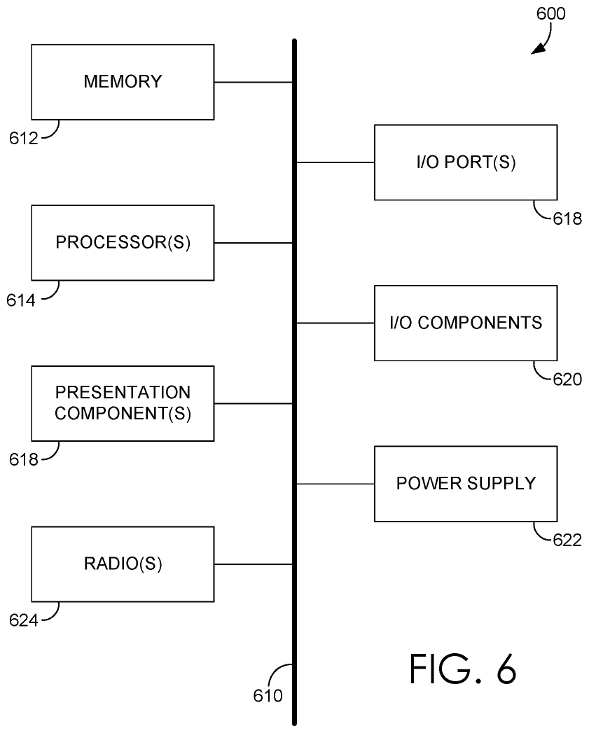

Additionally, a “user device,” as used herein, is a device that has the capability of using a wireless communications network, and may also be referred to as a “computing device,” “mobile device,” “wireless communication device,” or “user equipment” (“UE”). A user device, in some aspects, may take on a variety of forms, such as a PC, a laptop computer, a tablet, a mobile phone, a PDA, a server, or any other device that is capable of communicating with other devices (e.g., by transmitting or receiving a signal) using a wireless communication. A UE may be, in an embodiment, user device 600, described herein with respect to FIG. 6.

A computing device may additionally include internet-of-things devices, such as one or more of the following: a sensor, controller (e.g., a lighting controller, a thermostat), appliances (e.g., a smart refrigerator, a smart air conditioner, a smart alarm system), other internet-of-things devices, or combinations thereof. Internet-of-things devices may be stationary, mobile, or both. In some aspects, the computing device is associated with a vehicle (e.g., a video system in a car capable of receiving media content stored by a media device in a house when coupled to the media device via a local area network. In some aspects, the computing device comprises a medical device, a location monitor, a clock, other wireless communication devices, or combinations thereof.

Further, the term “telecommunications network service” provided by the IMS layer, as used herein, includes wireless communications via the transfer of information via one or more of the following: radio waves (e.g., Bluetooth®), satellite communication, infrared communication, microwave communication, Wi-Fi, and mobile communication. Telecommunications network services may be provided via one or more wireless telecommunication technologies or standards, including, but not limited to, CDMA 1×Advanced, GPRS, Ev-DO, TDMA, GSM, WiMax technology, LTE, LTE Advanced, 4G, 5G, 6G, or other generation communication systems, among other technologies and standards. The telecommunications network services may be provided via a network (e.g., the transfer of information without the use of an electrical conductor as the transferring medium).

In aspects, the network may be a telecommunications network(s), or a portion thereof. A telecommunications network might include an array of devices or components (e.g., one or more cell sites). The network can include multiple networks, and the network can be a network of networks. In embodiments, the network is a core network, such as an evolved packet core, which may include at least one mobility management entity, at least one serving gateway, and at least one Packet Data Network gateway. The mobility management entity may manage non-access stratum (e.g., control plane) functions such as mobility, authentication, and bearer management for other devices associated with the evolved packet core.

In some aspects, a telecommunications network can connect one or more subscribers to a corresponding immediate service provider for services such as 5G and LTE, for example. In aspects, a network provides voice, message (e.g., SMS messages, MMS messages, instant messaging messages, EMS messages), or data services to user devices or corresponding users that are registered or subscribed to utilize the services provided by a telecommunications provider. The network can comprise any communication network providing voice, message, or data service(s), such as, for example, a 1× circuit voice, a 3G network (e.g., CDMA, CDMA2000, WCDMA, GSM, UMTS), a 4G network (WiMAX, LTE, HSDPA), a 5G network, a 6G network, and any combination thereof.

Components of the network, such as terminals, links, and nodes (as well as other components), can provide connectivity in various implementations. For example, components of the network may include core network nodes, relay devices, integrated access and backhaul nodes, macro eNBs, small cell eNBs, gNBs, relay cell sites, or other network components. The network may interface with cell sites or access points through one or more wired or wireless backhauls. As such, the cell site and access point may communicate via the network or directly. Furthermore, user devices can utilize the network to communicate with other devices (e.g., a mobile device(s), a server(s), a personal computer(s), etc.) through the cell site or access point.

As used herein, the term “cell site” (used for providing UEs with access to the telecommunications network services) generally refers to one or more cellular base stations, nodes, RRUs control components, and the like (configured to provide a wireless interface between a wired network and a wirelessly connected user device). A cell site may comprise one or more nodes (e.g., eNB, gNB, and the like) that are configured to communicate with user devices. In some aspects, the cell site may include one or more band pass filters, radios, antenna arrays, power amplifiers, transmitters/receivers, digital signal processors, control electronics, GPS equipment, and the like. An eNB or gNB corresponding to the cell site may comprise one or more of a macro base station, a small cell or femto base station, a relay, and so forth. In aspects, the cell site may be configured as FD-MIMO, massive MIMO, MU-MIMO, cooperative MIMO, 3G, 4G, 5G, another generation communication system, or 802.11. In addition, the cell site may operate in an extremely high frequency region of the spectrum (e.g., from 30 GHz to 300 GHz), also known as the millimeter band.

Embodiments of the technology described herein may be embodied as, among other things, a method, system, or computer-program product. Accordingly, the embodiments may take the form of a hardware embodiment, or an embodiment combining software and hardware. An embodiment that takes the form of a computer-program product can include computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules—in a modulated data signal (e.g., a modulated data signal referring to a propagated signal that has one or more of its characteristics set or changed to encode information in the signal). Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

In an exemplary embodiment, a system is provided for facilitating cell site selection. The system includes one or more processors and one or more computer-readable media storing computer-usable instructions that, when executed by one or more of the processors, cause one or more of the processors to receive a first signal from a first cell site and second signal from a second cell site, determine that the first cell site is an approved cell site and the second cell site is a non-approved cell site, and connect to the first cell site based on the first cell site being the approved cell site. In some cases, the system determines that the second site is the non-approved cell site based on an irregularity associated with the second signal. The one or more processors can be further configured to determine that a connection to the second cell site is a default configuration, in embodiments. In some cases, the one or more processors in the system are further configured to override the default configuration of connecting to the second cell site based on the second cell site being the non-approved cell site.

Examples of embodiments include systems where a graylist is updated based on a failed authentication of the second site, and where one or more of the processors are further configured to originate a call to a public safety answering point (PSAP). In some cases, The system determining that the first cell site is the approved cell site and the second cell site is the non-approved cell site further comprises querying a locally stored data set.

In another exemplary embodiment, a method for facilitating cell site selection is provided, which includes, at a user equipment (UE), receiving a first broadcasted signal and a second broadcasted signal, determining that the first broadcasted signal is associated with a non-approved cell site, and ignoring the first broadcasted signal when attempting to connect to a wireless communication network. The method can further include receiving an indication from a carrier that the first broadcast signal is associated with the non-approved cell site. In some cases, the first broadcasted signal is associated with a non-approved device based on an irregularity associated with the first broadcast signal. In embodiments, the irregularity relates to a movement of the first broadcasted signal, for example based on one or more indications that a signal or source is not from a stable or permanent location (e.g., the signal or source may be from a laptop or other non-fixed device that can be transported, or that has been relocated or moved over time). Embodiments can distinguish a signal or source with movement from an approved or permanent source, such as a known base station or other structure. In some cases, the method also includes automatically receiving an updated indication about the first broadcasted signal subsequent to an expiration of the determination that the first broadcasted signal is associated with the non-approved cell site.

Other embodiments include, for example, a non-transitory computer readable media having instructions stored thereon that, when executed by one or more computer processing components, cause the one or more computer processing components to perform a method for facilitating cell site selection. The method can include, at a user equipment (UE), receiving synchronization signals from a first cell site and second cell site, originating a call to a public safety answering point (PSAP), querying a locally stored data set to determine that the first cell site is an approved cell site and the second cell site is a non-approved cell site, and overriding a default configuration to connect to the second cell site by connecting to the first cell site. In some cases, the second cell site is associated with a third party or a simulator.

In embodiments, the data set is stored on the UE and/or accessed by the UE. As one example, the data set is periodically updated by a component of a wireless communications network associated with the first cell site. As described herein, in embodiments, the second cell site is the non-approved cell site based on a characteristic associated with a frequency of a synchronization signal associated with the second cell site. In an exemplary embodiment, the second cell site is the non-approved cell site based on a first pseudo noise of a synchronization signal associated with the second cell site. Embodiments include a call to a PSAP that is a 911 call or other emergency service or notification call.

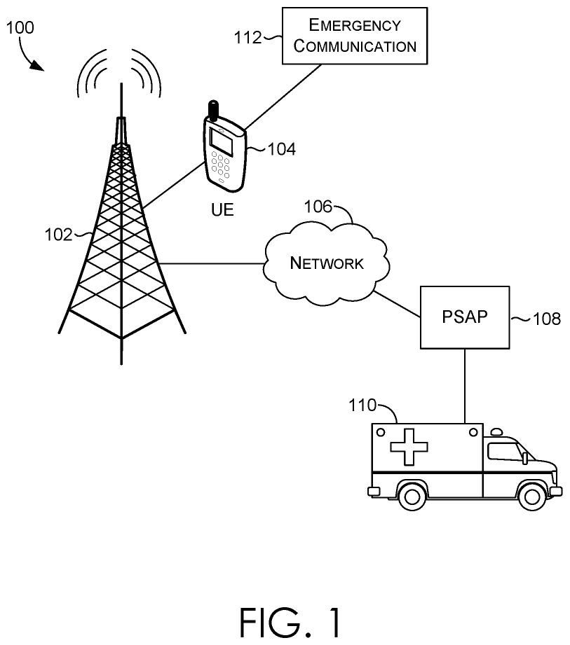

FIG. 1 shows an exemplary environment 100 for accessing and providing communication services. In this environment 100, a base station 102 broadcasts signals and establishes communications with devices, such as UE 104, over a network 106. By way of background, UE 104 is cellular user equipment, such as a cellular phone or other user device, in embodiments.

UE 104 can listen for broadcasting messages from various sources in order to select a cell or mobile network for connection. For example, UE 104 can perform a public land mobile network (PLMN) search or scan to identify the availability of nearby base stations, such as base station 102. Base station 102 belongs to a UE's home public land mobile network (HPLMN), to which the UE 104 is a subscriber, or base station 102 is visitor public land mobile network (VPLMN), which a UE could attach to when “roaming.” In some embodiments, base station 102 is a terrestrial cell site structure with antenna(s) to advertise signals to devices. In other embodiments, base station 102 is a satellite device, a portable and/or amplification device, or other structure that is used to provide communication services for a UE 104. A network, such as network 106, comprises one or more network devices in communication to send and/or receive information.

In some cases, UE 104 becomes associated with a Public-Safety Answering Point (PSAP) 108 over the network 106. PSAP 108 is used to provide emergency services 110 in response to an emergency communication 112 from UE 104. As one example, PSAP 108 represents devices or entities that receive emergency communications, such as 911 calls or emergency messages. In some cases, PSAP 108 is a call center or a distributed system for receiving and/or routing communications.

An emergency communication 112 is a phone call, in some cases. In other cases, an emergency communication 112 is a text message or other non-voice communication. For example, a certain button or series of buttons, or code, could be entered into UE 104 to trigger an emergency communication 112. UE 104 is a device that automatically triggers an emergency call or text, in embodiments, such as a device that detects a medical condition or other event, such as an impact or a voice command. UE 104 can include or be connected to a camera or sensor to detect an event, or it may comprise an Internet of Things (IoT) device with a capability to detect an emergency or receive an emergency communication. In some cases, emergency communications include communications relating to health, safety, a need to communicate, or time-sensitive information, as examples. Emergency services 110 includes responses from emergency or medical contacts, or other individuals or entities responding to communications. In some cases, an emergency communication 112 is routed through an emergency call relay center (ECRC) (not shown) before it is routed to PSAP 108.

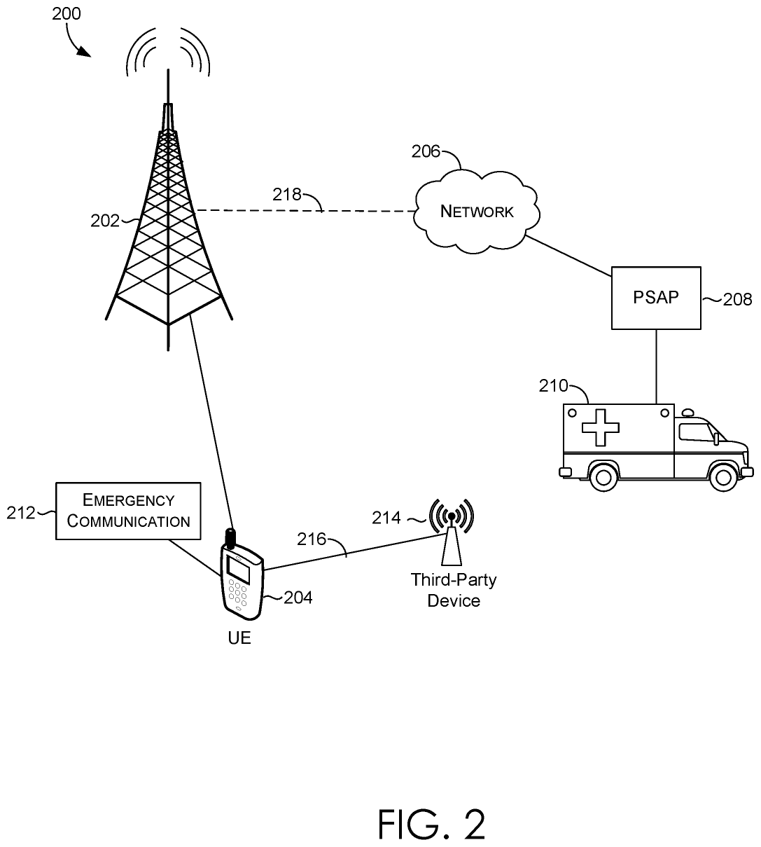

Turning to FIG. 2, a second environment 200 is shown, including base station 202 and UE 204. In this example, base station 202 is in communication with network 206, and PSAP 208 is in communication with base station 202 via network 206. PSAP 208 is also in communication with emergency services 210, such as recipients of 911 calls. As shown in this second environment 200, UE 204 is attempted to make an emergency communication 212, but UE 204 has not connected to network 206 based on a signal emitted by base station 202. Instead, UE 204 has connected to a third-party device 214.

In embodiments, a third-party device 214 broadcasts a signal that is based on a signal broadcast by a base station 202, in an effort to cause UE 204 to interact with the third-party device 214 instead of, or in addition to, base station 202. A third-party device 214 is a signal source that may impact or interfere with UE 204 attaching to a network 206. In some cases, UE 204 identifies a signal from third-party device 214 and establishes an attachment 216 to the third-party device 214. In some cases, attachment 216 is instead of any network attachment 218, while in some cases attachment 216 is in addition to a network attachment 218.

In embodiments, a third-party device 214 pretends to be a legitimate base station 202 by broadcasting messages or signals that “spoof” or imitate the signals emitted by base station 202. This may induce user devices, such as UE 204, to connect to the third-party device 214. Sometimes, a third-party device 214 registers itself as an authorized base station at the UE 204 or launches an attack. Although the third-party device 214 in this example is illustrated as a device, third-party device 214 can be a single, integrated device or separate components. As one example, a third-party device 214 includes a transceiver, a computing device such as a laptop, and a cellular phone. These components can be distributed, used by the same operator or team, and/or in communication with each other. In this example, a laptop controls radio signals being broadcasted by a transceiver, while a cellular phone is used to identify the messages being broadcast by a legitimate base station 202 for purposes of simulating such messages.

A third-party device 214 is a simulator or bad actor, for example. In some cases, a third-party device 214 is an International Mobile Subscriber Identifier (IMSI) catcher, or a “false” or “rogue” base station. A third-party device 214 can work by intercepting traffic from some or all user devices, such as UE 204, in an area. An operator of a third-party device 214 can track the location of UE 204, in embodiments, and access data and voice communications. A third-party device 214 can cause other effects in order to disrupt or exploit network communications, such as forcing a downgrade to a different or older network with less security. For example, a third-party device 214 could intercept communications associated with UE 204 that are intended to be handled by a 3G or higher network and cause such communications to be made using a 2G network. In some cases, a third-party device 214 is physically located on a person, such as inside a backpack, or it is mounted to a structure or vehicle. A malicious third-party device 214 may simulate a legitimate network component, such as base station 202, in order to launch passive attacks, such as tracking, or active attacks, such as injecting signals.

A third-party device 214, such as a malicious actor or simulator, causes certain problems related to handling communications from a UE 204. These problems are based on bad actors attempting to simulate a base station 202, and they are even more pronounced when UE 204 attempts to call or message emergency services 210. For example, UE 204 expends valuable time and resources attempting to establish a connection or attachment for communications, which are wasted if UE 204 is attempting to connect or attach to a bad actor, such as a third-party device 214.

It would be beneficial for UE 204 to avoid attempting to connect, or connecting, via a malicious third-party device 214, without spending time and resources. UE 204 could save resources by avoiding or ignoring a third-party device 214, at the outset of a communication and during a communication or session. For example, a UE 204 wastes time attempting to authenticate or otherwise use devices to communicate, which may require multiple steps or processes and may ultimately fail due to a third-party device 214 in communication with UE 204. UE 204 may request identifier(s) from a device such as base station 204 or third-party device 214. UE 204 may sever or discontinue attempting to attach if UE 204 does not receive proper identifier(s) within a specific time interval. A validation server (not shown) may be used and validation may be required, for example validation of base station 202 to establish a connection with a legitimate source.

A third-party device 214 can cause particular problems for a UE 204 attempting to communicate with other devices via a network 206. A third-party device 214 may cause UE 204 to establish a connection or attach to the third-party device 214. In this case, UE 204 is not properly linked to emergency system resources such as emergency services 210. This can cause increased use of energy and processing power, and a reduction in available power or battery life, in addition to disruption or unavailability of emergency services 210. An emergency communication 212 can be disrupted or disconnected if a third-party device 214 is communicating with UE 204. An emergency communication 212 may not be routed at all due to a third-party device 214, for example if the third-party device 214 has interfered with the assignment of a PSAP 208 to a session or device, such as UE 204.

In some cases, a third-party device 214 interferes with communication(s) from UE 204 related to location or other identifying or real-time information, such that emergency services 210 are impacted for UE 204. In some cases, if a malicious third-party device 214 is able to execute a passive or active attack due to its interactions with UE 214, even more resources of a UE 204 and/or resources of network 206 will be consumed or wasted, and network and user privacy and security will be at risk.

Embodiments described herein address handling or avoiding bad actors, such as third-party device 214, in a network 206 so that UE 204 can effectively communicate with emergency services 210. In an embodiment, one or more third-party devices, such as third-party device 214, are identified, which can cause UE 204 to be instructed to avoid attempting to connect via certain third-party devices, thereby facilitating the attachment of UE 204 to an authorized signal source such as base station 202. In embodiments, network providers are able to communicate indicators to other network providers or carriers to identify third-party devices such as third-party device 214. This indication or instruction can be preliminary or final, as discussed in more detail below, and it can be updated over time, to enable network provider(s) to cause UEs to ignore attempted connections from fraudulent sources.

One or more devices in network 206, or devices external to network 206, determine whether a third-party device 214 is present or likely to broadcast in an area. In embodiments, an indication of third-party devices is provided to UE 204 and/or used to cause UE 204 to ignore a certain third-party device 214 or associated signal. Embodiments determine whether a device or signal source is a third-party device 214, as opposed to an authorized source such as base station 202, in various ways. For example, certain rules are applied to prevent UE 204 from being handed off to a non-approved site, such as third-party device 214. In some cases, a carrier sets one or more criteria for identifying or indicating a third-party device 214 as a malicious device to be avoided, which can be a preliminary or time-dependent determination.

As one example, systems and methods described herein only permit a new attachment or hand off to a site that is determined to be authorized based on pseudo noise (PN). PN includes random noise or sequences that embodiments described herein can use to distinguish an approved signal or source from a non-approved or third-party site, such as third-party site 214. As one example, PN can appear random but may repeat or include a pattern. In some embodiments, PN can include or comprise a code or sequence that may repeat or may be deciphered by a certain devices. For example, UE 204 or other devices connected to a network 204 can recognize certain PN. In some cases, any sequence or series of noise that a device, such as UE 204, uses to determine whether a signal is recognized or not can be considered PN.

In some cases, UE 204 is only permitted to connect with devices using connections established based on authorized PN as the sole criteria, but in other cases this is used in combination with one or more other criteria. A determination of whether a broadcasted message or signal is from a third-party device 214 or a legitimate source, such as bases station 202, can be based on multiple factors, including the location, the associated cell type, and/or the carrier affiliation of the source or signal. These criteria can be used individually in in combination to determine if a source should be added to a list of malicious sources, such as third-party device 214.

Criteria can be determined based on irregularities detected related to a signal or source. In embodiments, irregularities are detected in the network layer. In some cases, an irregularity includes the strength or relative strength of a signal from a third-party device 214, which may be unusually strong. In some cases, an irregularity includes being the stronger of (or the second-stronger of) two sources or signals that have one or more similarities. In embodiments, an irregularity is detected based on a signal or source that is determined to be in motion or determined to have been in more than one location over time. In some cases, a change in signal strength can indicate motion or location changes associated with a signal or source, which is determined to be an irregularity. According to some embodiments, an irregularity is detected based on PN, such as unrecognized or inaccurate PN associated with one or more signals or sources.

Other criteria that can indicate an irregularity may be the detection of a legitimate network identifier but with a different tracking area code. In some cases, systems and methods can detect incorrect or “off-band” frequencies, atypical cell IDs, one or more supported features of a base station, such as base station 202, and/or a change in a criteria or condition over time, such as a loss of encryption. For example, if a signal or source, e.g., from a third-party device 214, is unstable or frequently updating in some respect, such as location updates, this can be used as a sole factor or in combination with other criteria to determine the device is a third-party device 214. In embodiments, the criteria includes one or more pieces of information identified by a carrier or provider about a third-party device 214. In some cases, a prior determination about a source or signal is the sole or primary consideration, for example a recent identification of a signal or source as coming from a third-party device 214.

As another example, a failure to authenticate can be a criteria or irregularity considered alone or in combination by a system to decide a device is a third-party device 214 as opposed to a trusted source such as base station 202. In embodiments, criteria can include information relating to silent SMS or empty messages or requests; rejections of certain communications; or empty or unknown values can be used to automatically determine a third-party device 214 is emitting a signal or messages. In some cases, a signal strength above a threshold level, or of varying levels, is used as a criteria. The criteria to be used to identify a third-party device 214 can automatically update over time. In embodiments, third-party sites, e.g., third-party site 214, are identified by systems using artificial intelligence, which can be trained on examples or data sets involving third-party sites. This can include machine learning, which can include ongoing data that is automatically received and added or used for training, in order for systems to automatically update themselves with respect to identifying third-party sites. This further includes deep learning and the use of neural networks, in embodiments. The third-party sites identified by embodiments are put on a dynamic list in a data set, in some cases, and the list can be pulled or pushed to UE 204 before UE 204 connects to a network, such as network 204, or as UE 204 moves or connects through new sources. In some embodiments, a list is locally stored on UE 204 as a local data set identifying one or more sites or signals as approved or non-approved.

Once a system has determined one or more third-party devices exist, such as third-party device 214, the system can automatically identify the device(s) for UE 204 and/or for other carriers or networks. In embodiments, a list is automatically generated to identify one or more third-party devices. In some cases, the list is a “blacklist” of devices that are “rejected” or to be avoided. In other cases, one or more devices are listed on a “graylist” as under watch or preliminarily blocked or to be ignored, until more information is available, for example a time period passing without an authentication of a device. After a condition is met, such as a threshold amount of time without an authentication, or a confirmation or recognition of one or more irregularities is obtained, a device on a “graylist” can be moved or added to a “blacklist.”

In accordance with embodiments, one or more devices will block or ignore a signal or messages from a third-party device 214 based on a “blacklist” and/or a “graylist.” A list may include various information to identify a third-party device 214 for UE 204 or other carriers or base stations. The information could include on or more of the following but is not limited to: software or hardware identifiers, authentication information, and/or information that indicates a source is a shadow or imitation source (e.g., third-party device 214) for a corresponding, legitimate source (such as base station 202). Potential identifiers include a frequency, such as a frequency range, a Base Station IDentifier (BSID), a tower identifier (e.g, a Cell-ID), a Permanent Equipment Identifier (PEI), and/or an IMSI, as examples.

In embodiments, a list includes one or more identifiers and an indication that, for the identified sources, only the second-strongest signal or authenticated versions of the sources should be used, while the non-authenticated or strongest signal is blacklisted. As an example, a list provided to UE 204 or a network device indicates a particular base station 202 is being simulated or spoofed by a bad actor, by indicating the pseudo noise or other characteristics associated with the bad actor only, so that UE 204 or a network device can distinguish between the legitimate source and the bad actor. In another example, a list only identifies characteristics of bad actors, such as third-party device 214, so that UE 204 or other devices can remove the bad actors from their list of neighbor or nearby sources, for example. As another example, a list is provided that identifies one or more characteristics of suspected bad actors (i.e., a “graylist”), which can include one or more identifying aspects of each suspected third-party device, so that UE 204 can avoid interacting with such devices until further confirmation or an expiration of a graylist.

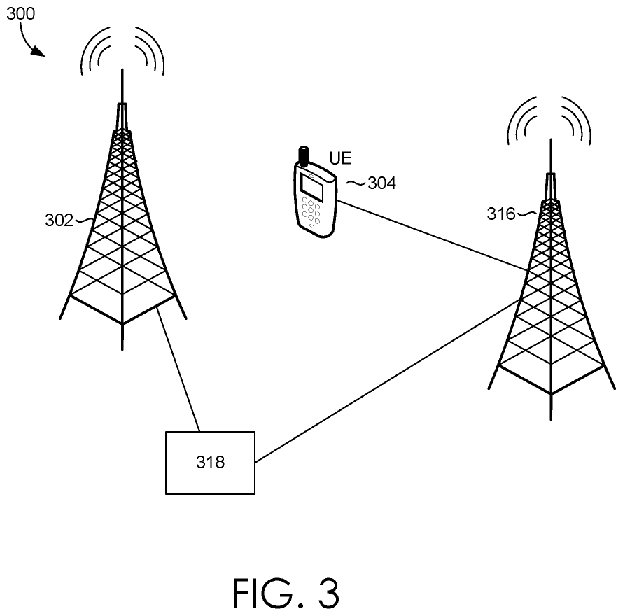

As one example, a list indicates more than one device associated with a particular area or signal, and the list indicates which of the devices is legitimate and/or malicious. A list, as discussed below with respect to FIG. 3, includes sufficient characteristics about devices or signal sources for UE 204 or other carrier networks to identify the third-party devices on the list. A list can indicate unusual power levels, shadow or duplicate signals, specific hardware or software IDs, etc., as discussed herein. A list is received over a network connection by UE 204, in embodiments, which causes UE 204 to remove or reject one or more third-party sites from it list of potential sources or connection options. In some cases, UE 204 is configured to select a connection option that is not on the list, or UE 204 is configured to require an authentication from a source identified on the list prior to a connection.

In embodiments, a carrier or network device provides a list comprising a “blacklist” to another carrier or network device, in order to cause the other carrier or network device to communicate to its affiliated user equipment that certain sites should be removed or ignored as connection options. As another example, the other carrier or network device may communicate a “graylist” so that user equipment can be instructed to preliminarily avoid a site. When the user equipment removes or ignores the third-party sites, the user equipment is successfully associated with a PSAP 208 and/or emergency services 210. In embodiments, UE 204 rejects or ignores a third-party site 214 for a period of time, then requests an update or detects changes or an expiration of a list. Carriers are able to push a list to devices, such as network devices and user equipment, based on the geographic area or other signaling.

In some embodiments, a network 206 determines a third-party device 214 is unauthorized or malicious, based on one or more criteria, and this information is shared to a centralized location, to one or more other networks, and/or to one or more user devices, such as UE 204. The information can be confirmed or updated by one or more other networks over time, and the information may expire after a predetermined time period. In some cases, the information is shared in a defined geographic area or in an area with a footprint similar to that of third-party device 214.

FIG. 3 shows another exemplary environment 300 in accordance with embodiments described herein. Base station 302 is shown in communication with UE 304, which may also be in communication with second base station 316, for example as UE 304 moves from one cell coverage area to another area. In some cases, only one base station, such as base station 302, is in communication with UE 304. In other examples, no base station is in communication with UE 304, but base station 302 and second base station 316 can be in communication with each other and/or one or more additional storage devices, such as storage device 318. Storage device 318 can be distributed or contained on or with one or more server or network devices. As one example, storage device 318 can be outside of or in communication with one or more networks (e.g., network 206), such that one or more base stations (e.g., base station 302) can provide or access lists regarding third-party devices (e.g., third-party device 214).

In embodiments, second base station 316 is associated with a second or separate carrier than base station 302. Base station 302 can provide a list to storage device 318, where it can be accessed by second base station 316 and/or UE 304. Store device 318 provides a centralized or shared data store for sharing information about third-party sites, such as third-party site 214. In some cases, systems described herein cause UE 304 to transmit a list it has received from a carrier or network device to its home carrier for further distribution or use in identifying bad actors. Different network devices or carriers are able to share information, such as lists regarding third-party sites, through a Multi-operator Core Network or Shared-RAN, in embodiments, or in a manner similar to or as part of a neighbor list or Neighbor Relation Table (NRT) that includes base station information.

As discussed above, embodiments described herein enable the saving of time and resources, which can be crucial in an emergency situation. In some cases, a mobile device such as UE 204 that is interacting with a third-party device 214 wastes time or resources, such as battery power, when it is attempting to connect with emergency services 210, and the UE 204 may not ever successfully connect with emergency services 210. An unauthorized third-party device 214 can also impact or interfere with non-emergency communications from UE 204, potentially leading to attacks. Embodiments described herein enable a mobile device, e.g., UE 204, to avoid malicious devices and associated risks, such as tracking or downgrading to a more vulnerable network. In embodiments, a list enables a UE 204 to maintain its network preference(s) because it maintains its interactions with legitimate devices.

Additionally, embodiments discourage or counteract bad actors who use strong signals (which may attract UE 204 but may also expose a signal as coming from a third-party device 214), and embodiments discourage or counteract bad actors who use moving signals (which may expose a non-fixed or non-base station source). For example, a bad actor is more likely to use a transportable or moveable signal or source, for convenience and/or to avoid detection, while a legitimate source is more likely to use a stable or non-moving signal or source, which can be used to distinguish approved signals from non-approved signals. In some cases, movement can be detected as it occurs, for example due to drift or other effects on a source or signal, or movement can be detected over time, for example even a source that appears stable could be detected as being in a new or different location compared to a previous point in time.

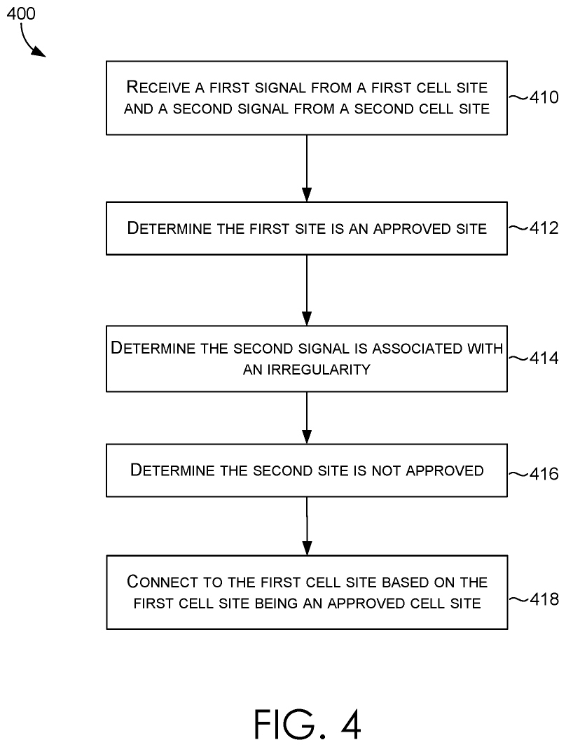

FIG. 4 illustrates a flow chart 400 with in aspects performed in accordance with embodiments. In the example in FIG. 4, a first signal is received form a first cell site and a second signal is received from a second cell site, as shown at 410. The signals can include or comprise certain frequencies or beacon messages that are advertised to mobile devices in a particular geographic area, such as a service area of cell area. At 412, a first site is determined to be an approved site. At 414, the second signal is determined to be associated with an irregularity, for example based on one more criteria, such as pseudo noise values or characteristics. At 416, it is determined the second site is non-approved site, for example via a blacklist or graylist that is provided to a shared repository or ledger, or that is provided to mobile devices (such as UE 304) in a particular area, such as where the non-approved signal reaches or in a radius around the location of a non-approved signal.

At 416, it is determined the second site is a non-approved site, such as a third-party site (e.g., third-party site 314), which is eliminated as a potential connection point based on its identification. In some cases, as shown at 418, a device such as UE 304 connects to the first cell site based on the determination that the first cell site is an approved cell site. In some cases, automatic updates may occur as new information is gathered and/or as new determinations are made, for example determinations based on artificial intelligence where new training or reference data continuously becomes available. In embodiments, computerized systems automatically update a blacklist or graylist based on learning over time and new characteristics that are detected.

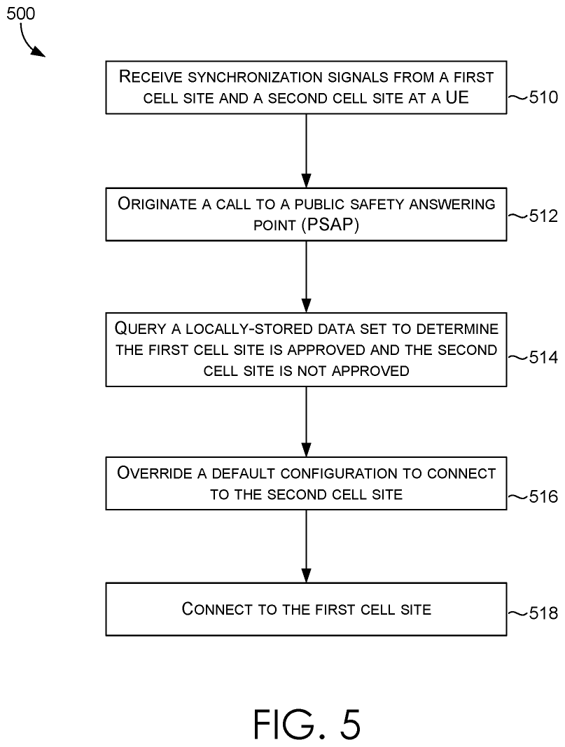

FIG. 5 illustrates a flow chart 500 in accordance with embodiments described herein. In the example shown in FIG. 5, at 510, synchronization signals are received from a first cell site and a second cell site at a UE, such as UE 304. For example, multiple frequencies can be detected by UE 304 in an area. An area can be geographically defined, or defined by cells or base stations. In embodiments, an area is a an area surrounding an approved site or an authorized network device that is monitoring for broadcasted signals, including simulated or malicious signals intended to lure UE into connections with non-approved devices. As shown at 512, a call to a PSAP is originated, for example from UE 304. At 514, a query to a locally-stored data set is made, to determine the first cell site is approved and/or that the second cell site is not approved. A data set can include, for example, a list with a reference to the frequency of the third-party source or signal, which may be provided to a UE 304 or to another carrier or network provider. In some cases, the data set or list is stored on the UE 304, or otherwise accessed or referenced by the UE 304. The data set can be updated by components of the wireless communications network, for example a data set can comprise a graylist that is updated to remove preliminary determinations of non-approved sites or to permanently list non-approved sites on a blacklist.

At 516, a default configuration to connect to the second cell site is overridden. In this example, a mobile device, such as UE 304, is prevented from communicating with the second cell cite, which is a third-party source. In some embodiments, this overriding can occur by removing a third-party device 314 from a list of potential sources from the perspective of UE 304. In some cases, UE 304 or a carrier network block certain sources or lock them from connection, either by removing references to the sources or, in some cases, by jamming or actively acting against the sources, for example to reduce their ability to attract devices (e.g., by weakening or impacting their signal so that UE 304 is unlikely to select the sources). In embodiments, a third-party site on a list flagged by UE 304 based on the list and thereby avoided when UE 304 scans potential sources in order to make connection attempts. Therefore, UE 304 avoids making connection attempts to a third-party site 314, in embodiments. When UE 304 is actively blocked from connecting to a non-approved device, or when references that point to the non-approved device are removed so that UE 304 cannot select them, UE 304 will attach to an approved base station 302, in embodiments. For example, the UE 304 connects to the first cell cite (the approved cell site), as shown at 518.

Referring now to FIG. 6, a diagram is depicted of an exemplary computing environment suitable for use in implementations of the present disclosure. In particular, the exemplary computer environment is shown and designated generally as computing device 600. Computing device 600 is but one example of a suitable computing environment and is not intended to suggest any limitation as to the scope of use or functionality of the invention. Neither should computing device 600 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 6, computing device 600 includes bus 602 that directly or indirectly couples the following devices: memory 604, one or more processors 606, one or more presentation components 608, input/output (I/O) ports 610, I/O components 612, power supply 614 and radio(s) 616. Bus 602 represents what may be one or more busses (such as an address bus, data bus, or combination thereof). Although the devices of FIG. 6 are shown with lines for the sake of clarity, in reality, delineating various components is not so clear, and metaphorically, the lines would more accurately be grey and fuzzy. For example, one may consider a presentation component, such as a display device to be one of I/O components 612. Also, processors, such as one or more processors 606, have memory. The present disclosure hereof recognizes that such is the nature of the art, and reiterates that FIG. 6 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 6 and refer to “computer” or “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data.

Computer storage media includes RAM, ROM, EEPROM, flash memory or other memory technology, CD-ROM, DVD or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

Memory 604 includes computer-storage media in the form of volatile and/or nonvolatile memory. Memory 604 may be removable, non-removable, or a combination thereof. Exemplary memory includes solid-state memory, hard drives, optical-disc drives, etc. Computing device 600 includes one or more processors 606 that read data from various entities, such as bus 602, memory 604, or I/O components 612. One or more presentation components 608 presents data indications to a person or other device. Exemplary one or more presentation components 608 include a display device, speaker, printing component, vibrating component, etc. I/O ports 610 allow computing device 600 to be logically coupled to other devices, including I/O components 612, some of which may be built in computing device 600. Illustrative I/O components 612 include a microphone, joystick, game pad, satellite dish, scanner, printer, wireless device, etc.

Radio 616 represents a radio that facilitates communication with a wireless telecommunications network. Illustrative wireless telecommunications technologies include CDMA, GPRS, TDMA, GSM, and the like. Radio 616 might additionally or alternatively facilitate other types of wireless communications including Wi-Fi, WiMAX, LTE, or other VoIP communications. As can be appreciated, in various embodiments, radio 616 can be configured to support multiple technologies and/or multiple radios can be utilized to support multiple technologies. A wireless telecommunications network might include an array of devices, which are not shown so as to not obscure more relevant aspects of the invention. Components, such as a base station, a communications tower, or even access points (as well as other components), can provide wireless connectivity in some embodiments.

Many different arrangements of the various components depicted, as well as components not shown, are possible without departing from the scope of the claims below. Embodiments of this technology have been described with the intent to be illustrative rather than be restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

What is claimed is:

1. A system for facilitating cell site selection, the system comprising:
one or more processors; and
one or more computer-readable media storing computer-usable instructions that, when executed by the one or more processors, cause the one or more processors to:
receive a first signal from a first cell site and second signal from a second cell site;
determine that the first cell site is an approved cell site and the second cell site is a non-approved cell site; and
connect to the first cell site based on the first cell site being the approved cell site.

2. The system of claim 1, wherein determining that the second site is the non-approved cell site is based on an irregularity associated with the second signal.

3. The system of claim 1, wherein the one or more processors are further configured to determine that a connection to the second cell site is a default configuration.

4. The system of claim 3, wherein the one or more processors are further configured to override the default configuration of connecting to the second cell site based on the second cell site being the non-approved cell site.

5. The system of claim 4, wherein a graylist is updated based on a failed authentication of the second site.

6. The system of claim 1, wherein the one or more processors are further configured to originate a call to a public safety answering point (PSAP).

7. The system of claim 1, wherein determining that the first cell site is the approved cell site and the second cell site is the non-approved cell site further comprises querying a locally stored data set.

8. A method for facilitating cell site selection, the method comprising:
at a user equipment (UE), receiving a first broadcasted signal and a second broadcasted signal;
determining that the first broadcasted signal is associated with a non-approved cell site; and
ignoring the first broadcasted signal when attempting to connect to a wireless communication network.

9. The method of claim 8, further comprising receiving an indication from a carrier that the first broadcast signal is associated with the non-approved cell site.

10. The method of claim 8, wherein the first broadcasted signal is associated with a non-approved device based on an irregularity associated with the first broadcast signal.

11. The method of claim 10, wherein the irregularity relates to a movement of the first broadcasted signal.

12. The method of claim 8, further comprising:
automatically receiving an updated indication about the first broadcasted signal subsequent to an expiration of the determination that the first broadcasted signal is associated with the non-approved cell site.

13. A non-transitory computer readable media having instructions stored thereon that, when executed by one or more computer processing components, cause the one or more computer processing components to perform a method for facilitating cell site selection, the method comprising:
at a user equipment (UE), receiving synchronization signals from a first cell site and second cell site;
originating a call to a public safety answering point (PSAP);
querying a locally stored data set to determine that the first cell site is an approved cell site and the second cell site is a non-approved cell site; and
overriding a default configuration to connect to the second cell site by connecting to the first cell site.

14. The non-transitory computer readable media of claim 13, wherein the data set is stored on the UE.

15. The non-transitory computer readable media of claim 13, wherein the data set is periodically updated by a component of a wireless communications network associated with the first cell site.

16. The non-transitory computer readable media of claim 13, wherein the second cell site is the non-approved cell site based on a characteristic associated with a frequency of a synchronization signal associated with the second cell site.

17. The non-transitory computer readable media of claim 13, wherein the second cell site is the non-approved cell site based on a first pseudo noise of a synchronization signal associated with the second cell site.

18. The non-transitory computer readable media of claim 13, wherein the data set is accessed by the UE.

19. The non-transitory computer readable media of claim 13, wherein the call to the PSAP is a 911 call.

20. The non-transitory computer readable media of claim 13, wherein the second cell site is associated with a third party or a simulator.
